(19) United States
(12) Patent Application Publication
(10) Pub. No.: US 2007/0119315 A1
(43) Pub. Date: May 31, 2007

(54) Personalized photo tote

(76) Inventors: Vanessa Denniston, Greenville, SC (US); Duff Bernard Wagner, Taylors, SC (US)

Correspondence Address: Legal Department;Milliken & Company, (M-495), 920 Milliken Road, P.O. Box 1926, Spartanburg, SC, 29304, US

(21) Appl. No.: 11/343,069

(22) Filed: Jan. 30, 2006

Related U.S. Application Data
(63) Continuation-in-part of application No. 11/269,224, filed on Nov. 8, 2005.

(51) Int. Cl. G03G 15/00

(52) U.S. Cl. 101/2; 112/475.05

(57) ABSTRACT

This invention relates to a process for producing a personalized photo tote comprising in order the steps of selecting a personalized image, personalized text and graphics, wherein the graphic are supplied by a software package, importing the graphics into a template, previewing the personalized image, personalized text, and template, printing the personalized image, personalized text, and template onto the requisite number of media sheets, and assembling the printed media sheets and project base components into the personalized photo tote.

### CROSS REFERENCE

This application, entitled PERSONALIZED PHOTO TOTE, is a continuation-in-part application of pending U.S. patent application Ser. No. 11/269,224, filed on Nov. 8, 2005 entitled PERSONALIZED MEMORY ALBUM.

### TECHNICAL FIELD

This invention relates to a method of making tote or bag. More particularly, the invention relates to a method of making a personalized photo tote using elements from software combined with user imputed elements.

### BACKGROUND

Most individuals value certain memories above others, and given the frail nature of human memory, desire aids which can help them retain and supplement these particularly valued memories. There are trends to personalize objects, with favorite colors, designs, sayings, and photographs.

In recent years, collectors and hobbyists have been using the so-called “scrapbooks” for retaining objects that have monetary or purely sentimental value. Some of the items retained in the scrapbook pages may be collectibles that have historic value, such as invitations to important political functions, concert tickets, letters from notable individuals and the like. However, majority of the individuals uses scrapbooks for retaining items of purely sentimental value, such as photographs, wedding invitations, graduation announcements, etc.

There is a trend towards customization and keeping of memories, not just in memory albums, but on clothing and accessories. There remains a need for individuals to be able to easily personalize their items with photographs and other embellishments, such as a purse or tote, especially for a small child.

### SUMMARY OF THE INVENTION

The present invention provides advantages and/or alternatives over the prior art by providing a process for producing a personalized photo tote comprising in order the steps of selecting a personalized image, personalized text and graphics, wherein the graphic are supplied by a software package, importing the graphics into a template, previewing the personalized image, personalized text, and template, printing the personalized image, personalized text, and template onto the requisite number of media sheets, and assembling the printed media sheets and project base components into the personalized photo tote.

### BRIEF DESCRIPTION OF THE DRAWINGS

The accompanying drawings which are incorporated in and which constitute a part of this specification illustrate several exemplary constructions and procedures in accordance with the present invention and, together with the general description of the invention given above and the detailed description set forth below, serve to explain the principles of the invention wherein:

FIG. 1 is an illustration of one embodiment of the personalized photo tote.

FIG. 2 is a flow chart representing the steps to create the photo tote.

FIG. 3 is an illustration of the template in which to import graphics.

### DETAILED DESCRIPTION OF THE INVENTION

The invention relates to a method of making a personalized photo tote. Personalized photographs, personalized texts, and graphics are printed out onto fabric media and assembled with project base. The method combines elements from a software package and inputs from the user and the project base components to form a personalized photo tote. The personalized photo tote may be sold as a craft kit. The craft kits may include a CD with a software package, fabric media sheets, and project base components.

The software will run on a computer and will direct activities for organizing and printing images. The software package guides the user through the steps to create and print the graphics in a template. The software package is preferably on a CD, but may also be on the internet or in any other computer storage medium.

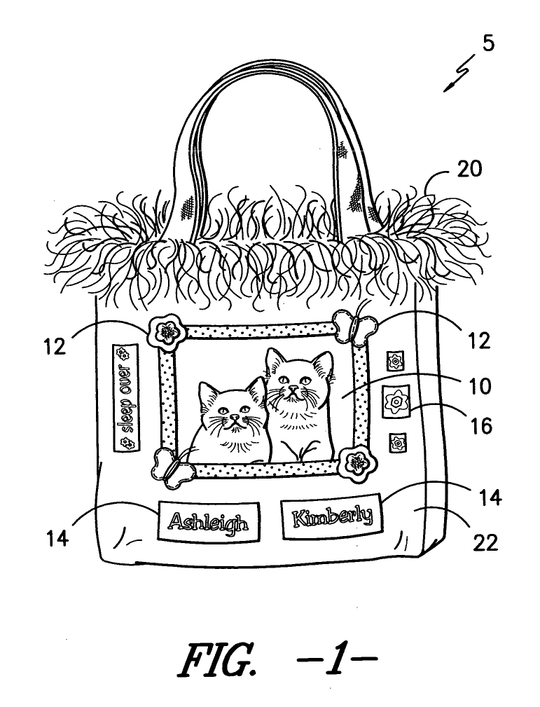

FIG. 1 shows one embodiment of the personalized photo tote 5. The tote 22 has two handles and an opening. The tote has a personalized image 10, personalized text 14, and graphics 16. The tote also has felt pieces 12 and tote opening trim 20. The tote may be multiple sizes but in one embodiment, it is approximately 10 cm by 10 cm.

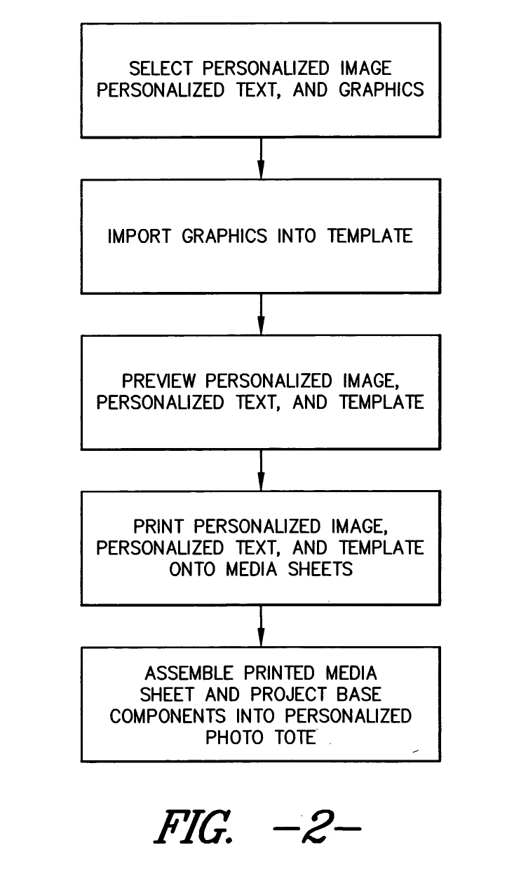

FIG. 2 shows flow chart representing the steps to create the photo tote. The method for producing a personalized photo tote begins with the user selecting personalized image(s), personalized text, and graphics. Next, the software program imports the graphics selected into a template to minimize the number of pages needed to print the selected graphics. The user previews the personalized image(s), text, and graphics and prints them onto media sheets. Then the user assembles the printed items with the project base components to form the personalized photo tote.

For the personalized photo tote 22, the user selects personalized text 14, such as a name or fun saying. Preferably, when the user inputs personalized text, the user also selects the font, size, text color, and background color of the text to control the look of the personalized text. In one embodiment, the software has a “what-you-see-is-what-you-get” viewing window on the display to show the user what the text with the personalized words, size, and font, will look like on the final product.

The personalized image(s) may be supplied by the user or provided by the software. The image is preferably a photograph. If the image is supplied by the user, the image is in a typical computer image format and may come from any source including the internet, a digital camera, or scanner. Preferably, the software also has stock images in which the user can select as the personalized image(s).

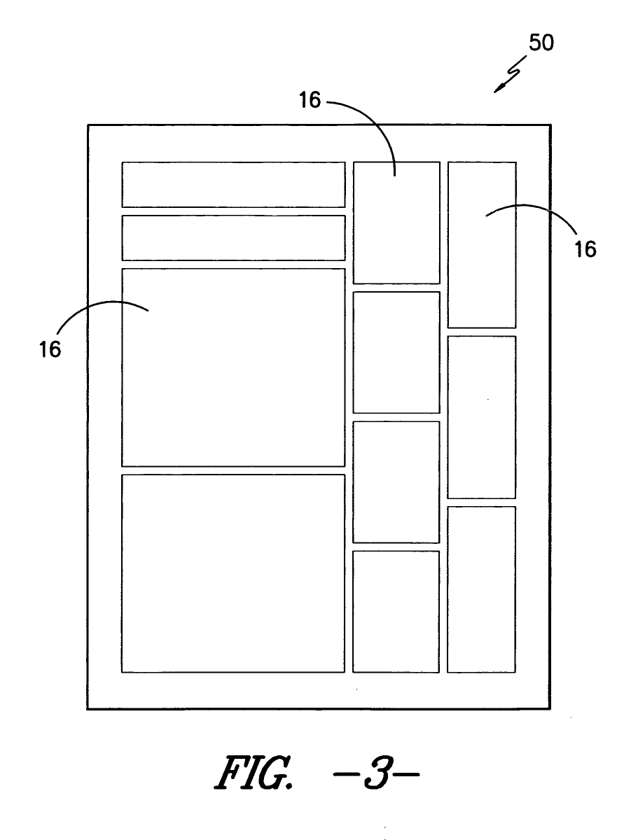

The user also selects graphics for the personalized photo tote. These graphs are supplied by the software program and are different shapes, designs, patterns, and colors. They may include graphics, cartoons, additional images, borders, or text. Once the user is done selecting the graphics for the tote, the graphic are imported into a template. When the graphics are imported into the template, they are arranged such so the maximum number of graphics fit on one page, thus using the minimum number of fabric media sheets necessary for printing. An illustration of a graphics template may be found in FIG. 3, wherein the template 50, has outlines 16 of where graphics would be imputed into the template.

Once the user has selected all of the personalized images 10, personalized text 14, and graphics 16, the software program saves these files in a graphical computer file, preferably a portable document file (.pdf) type file. It may also be a .jpg (lossy compressed 24 bit color image storage format developed by the Joint Photographic Experts Group), .bmp (bitmap), or .tiff (tagged image file format). The user previews this file to ensure that the elements selected are correct and then the user prints the files on the requisite number of fabric media sheets. If the user is not satisfied with the preview of any of the selected elements, the user can go back and change some or all of the personalized image, personalized text, and/or graphics.

If the user is satisfied with all of the selected elements, the personalized image 10, personalized text 14, and graphics 16 on the template are printed onto the requisite number of media sheets. The printing is preferably inkjet printing, but could be any digital printer such as a thermal, inkjet, electrophotographic, or silver halide printer.

The media sheets preferably have inkjet receiving chemistry in or on the sheets. The chemistry may be applied to the fibers before making the fabric, or applied to the formed fabric. Some inkjet receiving chemistries include fluorochemicals, silicones, resin-based finishes, waxes, wax-metal emulsions, organometallic complexes, ionic (cationic or anionic) materials, and combinations thereof. It is believed that the repellant properties of the repellant finish chemicals help prevent the colorant from being absorbed into the textile, and facilitates allowing the colorant to fill the entire intended zone for the colorant. Details about some inkjet receiving chemistries may be found in U.S. Pat. Nos. 6,936,076 and 6,749,641.

The media sheets are preferably fabric, but may also be any printable stock, such as paper, cardboard, handmade paper, and plastic (such as vinyl). The fabric of the fabric media sheets can be a woven, knitted, non-woven material, tufted materials, or the like. Woven textiles can include, but are not limited to, satin, poplin, and crepe weave textiles. Knit textiles can include, but are not limited to, circular knit, warp knit, and warp knit with a microdenier face. The textile may be flat, or may exhibit a pile. Such textile materials can be formed of natural or synthetic fibers, such as polyester, nylon, wool, cotton, silk, polypropylene, rayon, lyocell, poly(lactide), acrylic, and the like, including textile materials containing mixtures and combinations of such natural and synthetic fibers.

Preferably, the fabric media sheets have an adhesive and a release liner on one side of the fabric. The non-adhesive side of the fabric sheet is the side printed on. The adhesive composition may contain epoxy, phenoformaldehyde, polyvinyl butyral, cyanoacrylates, rubber based adhesives, styrene/butadiene based adhesives, acrylics, and vinyl derivatives. The adhesive is preferably a permanent adhesive or an adhesive that is repositionable for a designated amount of time then becomes permanent.

Once all of the fabric media sheets are printed, the personalized photo tote is assembled. The project base components preferably are the tote 22, tote opening trim 20, and embellishments 12. Assembly begins with the tote 22. The tote 22 may be supplied by the craft kit, but the user may also use one of their totes or purses for the project. Preferably, the tote is already formed with handles. The user cuts out the personalized image(s) 10, personalized text 14, and graphics 16 out of the fabric media sheets, removes the backing liner off of the sheets and applies the images 10, text 14, and graphics 16 to the tote 22, adhesive side towards the tote 22. In another embodiment, the fabric media sheets may be ironed or sewn onto the tote.

Next, the embellishments 12 are added to the tote 22. These can comprise ribbons, feathers, felt pieces (or decorations), and tote opening trim 20 (which may be feather boas, leather strips, other decorative items). In one embodiment, the tote opening trim 20 is applied first (with double sided tape or thread) and then the rest of the tote 22 is decorated with other items. In one embodiment, the items added to the tote 22 include both project base components and other items from the user. The user may add double sided clear adhesive tape and then apply clear, holeless beads to the tape to create a 3-D effect. Other addenda may be added include but not limited to glitter, holographic images, lenticular images, and puff paint. The photo tote may also include one or more tie members, ribbons, zippers, or Velcro to close the top of the tote.

What is claimed is:

1. A process for producing a personalized photo tote comprising in order the steps of:
selecting a personalized image, personalized text and graphics, wherein the graphic are supplied by a software package;
importing the graphics into a template;
previewing the personalized image, personalized text, and template;
printing the personalized image, personalized text, and template onto the requisite number of media sheets; and,
assembling the printed media sheets and project base components into the personalized photo tote.

2. The process of claim 1, wherein the media sheets comprise fabric.

3. The process of claim 1, wherein the software package comprises a plurality of graphics.

4. The process of claim 1, wherein the graphics are imported and arranged in a template such that the number of media sheets needed to be printed is minimized.

5. The process of claim 1, wherein selecting personalized text includes selecting size, font, and color of the text.

6. The process of claim 1, wherein the personalized image is provided by the user.

7. The process of claim 1, wherein the personalized image is supplied from the software package.

8. The process of claim 1, wherein the collected image file is a portable document file.

9. The process of claim 1, wherein the media sheets comprise an inkjet receiving layer.

10. The process of claim 2, wherein the fabric media sheets comprise a knitted fabric.

11. The process of claim 2, wherein the fabric media sheets comprise a woven fabric.

12. The process of claim 2, wherein the fabric media sheets comprise an adhesive layer and release liner on one side of the fabric media sheet.

13. The process of claim 1, wherein the printing the collected image file comprises inkjet printing.

14. The process of claim 1, wherein the project base components comprise a tote, tote opening trim, and embellishments.

15. The process of claim 1, wherein assembling the printed media sheets and project base components comprises:
cutting the personalized image, personalized text, and graphics out of the printed media sheets;
applying the personalized image, personalized text, and graphics to the tote;
applying the tote opening trim to the tote; and,
applying the embellishments to the tote.

16. The process of claim 14, wherein the embellishments comprise felt decorations and ribbon.

17. The process of claim 15, wherein the embellishments are applied to the tote using double sided adhesive tape.
